(19) United States
(12) Patent Application Publication
(10) Pub. No.: US 2014/0060939 A1
(43) Pub. Date: Mar. 6, 2014

(54) LOAD-MEASURING, FLEET ASSET TRACKING AND DATA MANAGEMENT SYSTEM FOR LOAD-LIFTING VEHICLES

(71) Applicant: David Aaron Eppert, Delta, CA (US)

(72) Inventor: David Aaron Eppert, Delta, CA (US)

(21) Appl. No.: 14/004,884

(22) PCT Filed: May 11, 2012
(86) PCT No.: PCT/CA12/50313

§ 371 Date: Sep. 12, 2013

Related U.S. Application Data
(60) Provisional application No. 61/485,866, filed on May 13, 2011.

(51) Int. Cl. G01G 19/10

(52) U.S. Cl. CPC G01G 19/10
USPC 177/1; 177/139; 177/25.13

(57) ABSTRACT

There is provided a system for monitoring payload for a load-lifting vehicle. The vehicle has a lifting arm and a hydraulic actuator operatively connected to the lifting arm. The system has a means for correlating actuator pressure within the actuator at a set position of the lifting arm with weight for generating a calculated weight of a payload. The system has a means for generating a payload pattern relating actuator pressure to time as the lifting arm moves the payload through a load cycle. The system has a means for comparing the payload pattern with a set pattern relating pressure to time corresponding to said calculated weight of the payload and storing the calculated weight of the payload into memory if the deviation between the patterns is equal to or less than a certain amount.

### CROSS REFERENCE TO RELATED APPLICATION

This application claims the benefit of provisional application No. 61/485,866 filed in the United States Patent and Trademark Office on May 13, 2011, the disclosure of which is incorporated herein by reference and priority to which is claimed.

### FIELD OF THE INVENTION

The present invention relates to a load-measuring, fleet asset tracking and data management system. In particular, the invention relates to a load-measuring, fleet asset tracking and data management system for load-lifting vehicles and shipping container loaders.

### DESCRIPTION OF THE RELATED ART

U.S. Pat. No. 4,919,222 to Kyrtsos et al. discloses a dynamic payload monitor for measuring and displaying a payload weight for a loader vehicle. It does so by sensing the hydraulic pressure and position of the lifting arm cylinders. The system includes a calibration step where the operator moves an empty loader bucket through a load cycle. The monitor has a load cycle reset control for specifying the beginning of the load cycle, at which point the operator can reset the calibration data. A first parabolic curve is generated representing curve fitted pressure versus extension data for the empty loader bucket. The calibration process is next repeated for a known weight and a second parabolic curve is generated thereby.

The payload weight is computed by curve-fitting the sensed pressure and position data to a second order polynomial, and then by performing interpolation or extrapolation with the pair of pressure versus position reference parabolas obtained during calibration.

However, the above system may experience weight drift unbeknownst to the operator if a change in the mechanical system occurs. For example, a known weight of 1,200 pounds, that the system previously determined to be weigh 1,200 pounds, may now read as 1,250 pounds. This weight drift may occur through hydraulic leakage in the system, or if one of the cylinders becomes faulty for example. The pressure transducer may also tend to drift over time and need to be reconfigured at various times during its life cycle. Weight and transducer drift may lead to inaccuracies in payload measurements. To minimize this drift, the system may have to be periodically re-calibrated, which may be relatively time consuming.

U.S. Pat. No. 5,082,071 to Kyrtsos et al. discloses a payload monitoring system where pressure versus extension characteristics for a preselected number of discrete known payloads are determined experimentally for the vehicle and stored into memory as curve-fitted second order polynomials. When a load of unknown weight is measured, each data point along the load cycle is compared to the pressure versus extension characteristics of known payloads. The second order polynomial that best fits with these data points is used to determine the weight of the load.

Here too this system may experience weight drift if a change in the mechanical system and/or transducer drift occur. The weight drift and/or transducer drift may affect the curvatures of the pressure versus extension characteristics. This may lead to inaccuracies in payload measurements. To minimize these inaccuracies, this system may have to periodically repeat its experimental storing of a series of preselected numbers of discrete payloads to determine a new set of second order polynomials, which here too may be relatively time consuming.

There is accordingly a need for a system that identifies when a change in the mechanical system and/or a change in the transducer has occurred to signal when re-calibrating the payload monitoring system is required.

### BRIEF SUMMARY OF INVENTION

The present invention provides a load-measuring, fleet asset tracking and data management system for load-lifting vehicles and shipping container loaders disclosed herein that overcomes the above disadvantages. It is an object of the present invention to provide an improved load-measuring, fleet asset tracking and data management system for load-lifting vehicles and shipping container loaders.

There is accordingly provided a system for monitoring payload for a load-lifting vehicle. The vehicle has a lifting arm and a hydraulic actuator operatively connected to the lifting arm. The system has a means for correlating actuator pressure within the actuator at a set position of the lifting arm with weight for generating a calculated weight of a payload. The system has a means for generating a payload pattern relating actuator pressure to time as the lifting arm moves the payload through a load cycle. The system has a means for comparing the payload pattern with a set pattern relating pressure to time corresponding to the calculated weight of the payload and storing the calculated weight of the payload into memory if the deviation between the patterns is equal to or less than a certain amount.

According to another aspect, there is provided a payload monitoring system for a load-lifting vehicle having a lifting arm and a hydraulic actuator operatively connected to the lifting arm. The system has a means for determining a calculated weight of a payload when the payload is stationary. The system has a means for generating and storing a plurality of set patterns relating actuator pressure to time as the lifting arm moves through a load cycle for a plurality of loads of known weights moved through the load cycle under a plurality of rates of flow of hydraulic fluid passing into and out of the actuator. The system includes a means for generating a payload pattern relating actuator pressure to time as the lifting arm moves the payload through the load cycle and verifying the calculated weight of the payload with one of the set patterns generated from both a load of known weight corresponding to the calculated weight of the payload and a rate of flow of hydraulic fluid passing into and out of the actuator corresponding to that at which the payload was moved through the load cycle.

According to a further aspect, there is provided a method of monitoring payload for a load-lifting vehicle. The vehicle has a lifting arm and a hydraulic actuator operatively connected to the lifting arm. The method includes hydraulically connecting a transducer to the actuator for sensing pressure therein. The transducer converting the pressure into electrical signals related thereto. The method includes positioning the lifting arm in an unloaded state to a set position and determining a first signal from the transducer in the set position. The method includes disposing a load of known weight on the lifting arm, determining a second signal from the transducer while the lifting arm is in the set position, and correlating a relationship between the first signal and the second signal and weight on the lifting arm therefrom. The method includes positioning a payload on the lifting arm, determining a third signal from the transducer while the lifting arm is in the set position, and determining a calculated weight of the payload based on the relationship. The method includes moving the payload through a load cycle at a rate of flow of hydraulic fluid passing into and out of the actuator where the payload is lifted a distance from the set position, measuring signals of the transducer at a series of points along the load cycle, generating a payload pattern based on the series of points, and comparing the payload pattern with a set pattern corresponding to the calculated weight of the payload and the rate of flow of hydraulic fluid. The method includes repeating the above steps if the deviation between the payload pattern and the set pattern is greater than a certain amount.

### BRIEF DESCRIPTION OF DRAWINGS

The invention will be more readily understood from the following description of preferred embodiments thereof given, by way of example only, with reference to the accompanying drawings, in which:

FIG. 1 is a side elevation view of a waste disposal vehicle together with a load measuring system according to a first embodiment, the system including a hydraulic transducer shown diagrammatically;

FIG. 2 is a flow chart of part of the system of FIG. 1;

FIG. 3 is a side elevation view of the vehicle shown in FIG. 1 together with a load measuring system according to a second embodiment, the system including a hydraulic transducer and a rotatory mechanical switch shown diagrammatically;

FIG. 4 is an enlarged view of an arm cylinder of the vehicle shown in FIG. 3, together with the switch of FIG. 3 shown diagrammatically;

FIG. 5 is a side elevation view of the vehicle shown in FIG. 1 with a load measuring system according to a third embodiment, the system including a hydraulic transducer shown diagrammatically, and the system being shown when the vehicle is free of a waste container;

FIG. 6 is a side elevation view of the vehicle and load measuring system shown in FIG. 5, together with a waste container containing a waste load, the system being shown with the forks of the vehicle lifting the container slightly off the ground;

FIG. 7 is a side elevation view of the vehicle and load measuring system shown in FIG. 5, the system being shown with the waste container raised and being emptied of its waste load;

FIG. 8 is a side elevation view of the vehicle and load measuring system shown in FIG. 5 together with the waste container, the system being shown with the waste container empty and lifted slightly off of the ground by the forks; and

FIG. 9 is a perspective view of the vehicle shown in FIG. 1 together with a load measuring system according to a fourth embodiment, the system including a plurality of load cells shown diagrammatically;

FIG. 10 is a bottom plan view of the vehicle of FIG. 9;

FIG. 11 is a side elevation view of the vehicle shown in FIG. 1 with a load measuring system according to a fifth embodiment, the system being shown when the vehicle has an unloaded waste container;

FIG. 12 is a side elevation view of the vehicle and system of FIG. 11, with the vehicle carrying a load of known weight;

FIG. 13 is a side elevation view of the vehicle and system of FIG. 11, with the vehicle carrying a waste load;

FIG. 14 is a flow chart of a calibration method for the system shown in FIGS. 11 to 13;

FIG. 15 is a flow chart for determining the weight of the waste load of FIG. 13 for the system shown in FIGS. 11 to 14;

FIG. 16 is a graph for the system of FIGS. 11 to 15, the graph showing a plurality of set patterns relating actuator pressure to time corresponding to loads of known weights going through load cycles at various speeds;

FIG. 17 is a flow chart of a method of tracking payloads for the system of FIGS. 11 to 16; and

FIG. 18 is a flow chart of a method of tracking payloads for the system of FIGS. 11 to 16, the method including a charge-by-weight system.

### DESCRIPTION OF THE PREFERRED EMBODIMENTS

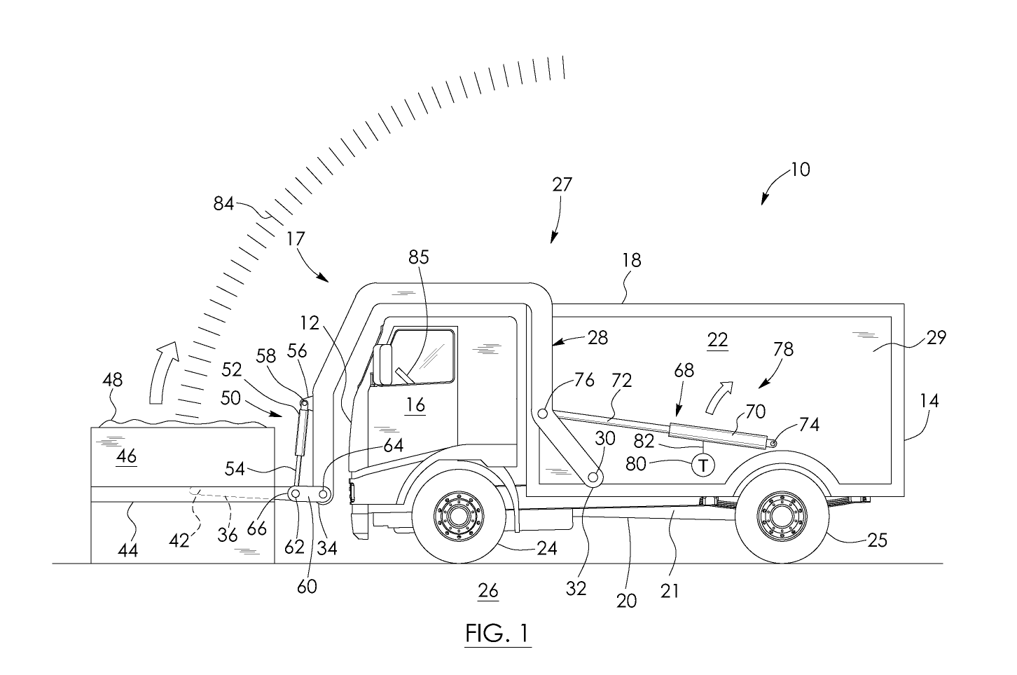

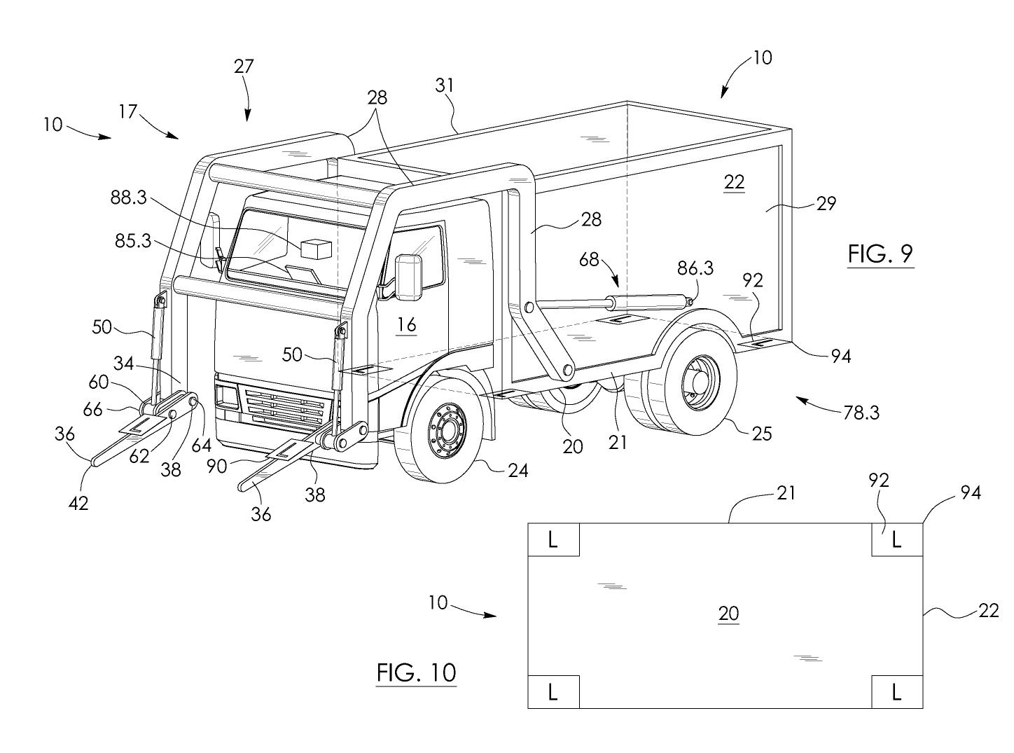

Referring to the drawings and first to FIG. 1, there is shown a load-lifting vehicle, in this example a front loading, waste collecting vehicle 10. The vehicle is conventional and has a front 12, a rear 14 opposite the front, a cab 16 adjacent to its front, a top 18, and a bottom 20 opposite the top. As best seen in FIG. 9, the vehicle 10 has a first side 29 and a second side 31 spaced-apart from the first side. The sides extend from front 12 to rear 14. Referring back to FIG. 1, the vehicle has a rectangular frame 21 disposed adjacent to the bottom, a receptacle, in this example a hopper 22 mounted to the frame and adjacent to the vehicle's rear, and two pairs of ground-engaging wheels, as shown by wheels 24 and 25, engaging ground 26.

Vehicle 10 has a load-lifting system 27 which includes a pair of lifting arms 28, as best shown in FIG. 9, pivotally connected to respective sides 29 and 31 of the vehicle. The arms are spaced-apart and each has a generally inverted u-shape. The arms 28 extend around cab 16 in this example in the lowered position 17 of the arms shown in FIGS. 1 and 9. Only one arm 28 is shown in FIG. 1 and thus only this arm will be described in detail, with the understanding that the other of the arms is substantially the same, with similar parts and function. Arm 28 has a first end 32 adjacent to bottom 20 of the vehicle and wheel 24. The first end of the arm pivotally connects to the vehicle via pivot pin 30. The arm has a second end 34 spaced-apart from the end 32. The second end of the arm is disposed adjacent to and is spaced-apart from the front 12 of the vehicle in the lowered position 17 of the arms shown in FIG. 1.

The load-lifting system 27 has a pair of spaced-apart forks 36, as shown in FIG. 9, and of which only one fork 36 is shown in FIG. 1. Each of the forks is substantially the same in parts and function. Each fork has a first end 38, as best seen in FIG. 9, disposed adjacent to front 12 of the vehicle and which pivotally connects to end 34 of arm 28 via pivot pin 64. Fork 36 has a second end 42 opposite end 38 and which is spaced-apart from the front end of the vehicle. End 42 of the fork may engage with one of the sleeves 44 of a waste container 46, as seen in FIG. 1. Container 46 contains a waste load 48 in FIG. 1.

The load-lifting system 27 has a pair of fork actuators, in this example, hydraulic actuators 50, as shown in FIG. 9, and of which only one actuator 50 is shown in FIG. 1. Only this actuator will be described in detail with the understanding that the other actuator is substantially the same in parts and function. As shown in FIG. 1, each actuator has a hydraulic cylinder 52 and a rod 54 configured to selectively retract within and extend outwards from the cylinder upon pressurized hydraulic fluid being added to or removed from the cylinder. In this example, cylinder 52 pivotally connects to arm 28 via a link 56 connected to and extending from the arm. The link is spaced-apart from end 34 of the arm towards top 18 of the vehicle. A pivot pin 58 pivotally connects link 56 to cylinder 52. Rod 54 pivotally connects to end 34 of arm 28, seen in FIG. 9, via a connecting link 60. In particular, the rod pivotally connects to link 60 via pivot pin 62 and link 60 pivotally connects to end 34 of the arm via pivot pin 64. End 66 of link 60 adjacent to pivot pin 62 is disposed adjacent to fork 36.

When hydraulic fluid is added to cylinder 52, rod 54 retracts upwards, causing end 66 of link 60 to raise fork 36 upwards, from the perspective of FIG. 1. Similarly, removing pressurized fluid to the cylinder moves the rod outwards, causing the link and thus the fork to lower.

The load-lifting system 27 has a pair of arm actuators 68, in this example, hydraulic actuators disposed adjacent to respective sides of the vehicle and of which only actuator 68 is shown. The other of the actuators is on the opposite side of the vehicle and is substantially the same in parts and function and therefore only one actuator will be described in detail. Each actuator 68 has a cylinder 70 and a rod 72 disposed to retract within and extend outwards from the cylinder upon the withdrawal or application of pressurized hydraulic fluid to the cylinder. In this example, cylinder 70 pivotally connects to the vehicle via a pivot pin 74 located adjacent to bottom 20 of the vehicle and spaced-apart from rear 14 of the vehicle. Rod 72 pivotally connects to arm 28 via pivot pin 76, which is spaced-apart from the end 32 of the arm and is disposed adjacent to cab 16.

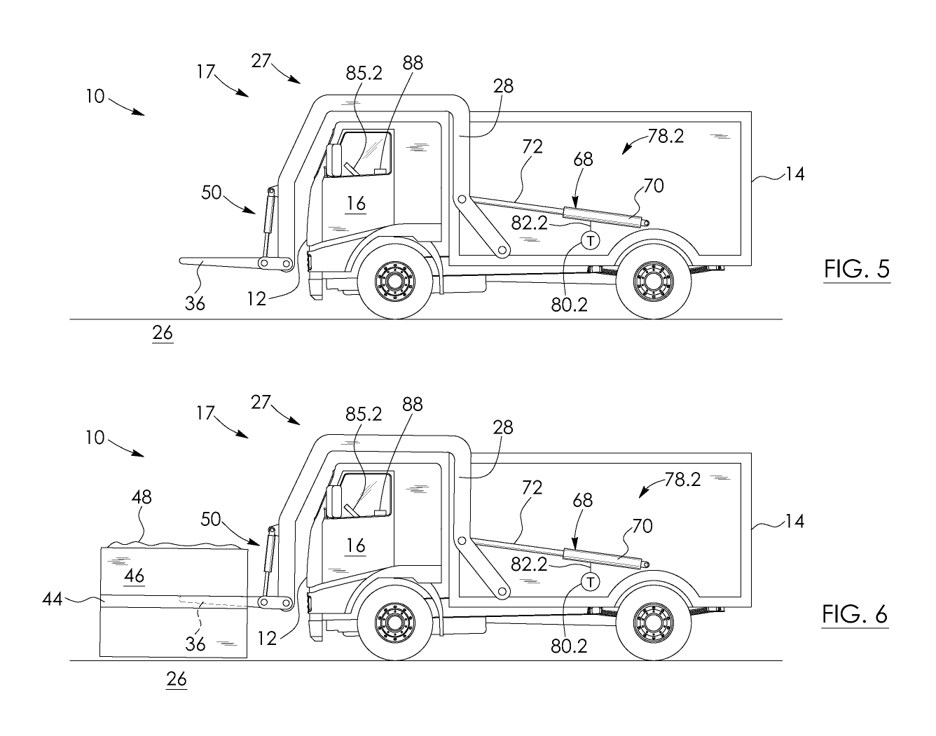

When hydraulic fluid is added to cylinder 70, rod 72 retracts within the cylinder, as shown in FIG. 6, causing end 34 of arm 28 to rise upwards, from the perspective of FIG. 6. Similarly, removing pressurized fluid to the cylinder actuates the rod outwards, causing the link and thus the fork to move towards a lower position, as is shown in FIG. 1.

Vehicle 10 has a load-measuring system 78 which includes at least one transducer and in this example a pair of transducers, one for each arm 28. In this example the transducers are hydraulic pressure transducers and only transducer 80 is shown schematically in FIG. 1. The transducers per se are conventional, off-the-shelf components well known to those skilled in the art and therefore their parts and operation will not be described in detail. The transducer 80 is in communication with the hydraulic fluid within cylinder 70 via hydraulic line 82, in this example. Hydraulic pressure within cylinder 70 is sensed by the hydraulic transducer, in response to which the transducer 80 sends out an electrical output. The transducer continually transmits output signals. In this example, the transducer is supplied with 12 volts (DC) and continually outputs a current in the range of 4 to 20 milliamps. In one example, pressures within the arm's cylinder in the range of 1800 to 2200 psi may correspond to payloads of 0 to 2500 kilograms. In this case, a 0 to 3000 psi transducer is used, which generates 4 to 20 milliamps.

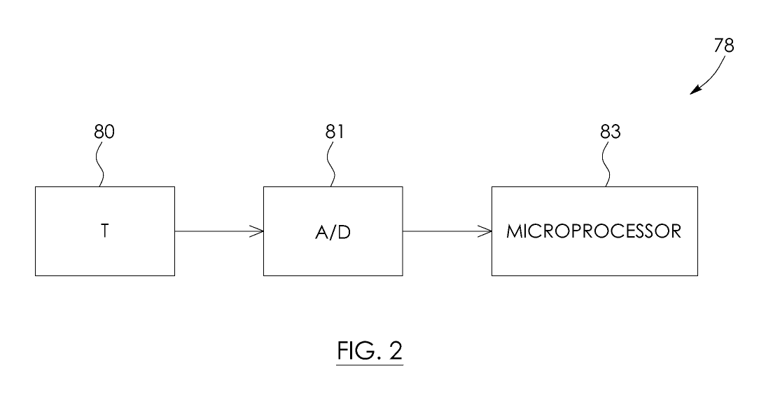

The system 78 also includes a controller, in this example a microprocessor 83, shown in FIG. 2, which is part of a computer 85 disposed within cab 16, as shown in FIG. 1. The microprocessor is configured to receive the output of the transducer 80 via an analog to digital converter 81, seen in FIG. 2. These transducer outputs are communicated to the computer and a relationship between current readings, the relative angular position of the arms 28, and the weight of the waste load is determined.

As the angular position of the arms changes, as indicated by dashes having numeral 84 in FIG. 1, the hydraulic pressure within the cylinders changes. The differences in hydraulic fluid pressures within cylinder 70 for adjacent angular positions 84 are the same for a given weight of waste load, in this example waste load 48, regardless of vehicle loads or fork position. Thus, the weight of waste load 48 may be determined from the transducer's continuous stream of milliamp readings inputted to and captured by the computer 85.

As the vehicle moves through a load cycle along dashes 84, a continuous stream of pressure readings provides a continuous stream of different voltages. The voltage readings correlate to weight readings. In this manner, the weights of a plurality of waste load, or payloads, from a plurality of waste containers may be calculated by the computer and stored within the computer in a dynamic, efficient and continuous manner. This may be referred to as a means for correlating actuator pressure within the actuator at a set position of the lifting arm with weight for generating a calculated weight of a payload.

The weights of given payloads thus calculated may then be communicated via computer 85 to a central corporate office or waste load tracking control center by, for example, wireless or cellular transmission. In this manner, the data from various vehicles and their various accumulated payloads may be acquired and stored within a central, fleet data management system.

The system 78 may be readily used for excavators, for example, which provide a good example of the variety of load dynamics. Excavators' arms may reach out for short or long digging motions depending on the requirements of the task. Weight measurements of a given load will vary based the angle and degree of extension of the arm, causing the load environment to be very dynamic. The more dynamic the environment, the more data is needed from the transducers to determine the reference points and the weight of the load that is being lifted.

This is in contrast to less dynamic systems, such as fork lifts, which may primarily have merely up and down motions. For such vehicles that have a less dynamic environment, fewer transducer readings are needed to determine the relevant reference points and the weight of the load that is being lifted.

As mentioned above, system 78 has a transducer 80 for each of the cylinders 70 in this example. This allows the transducers to send a pair of parallel output signals, which may provide a redundancy in measurements to allow for a margin of error and quality control. Having separate transducers for each arm 28 also enables the computer to determine if one side 29 or 31 of the vehicle 10 and/or container 46 is heavier than the other.

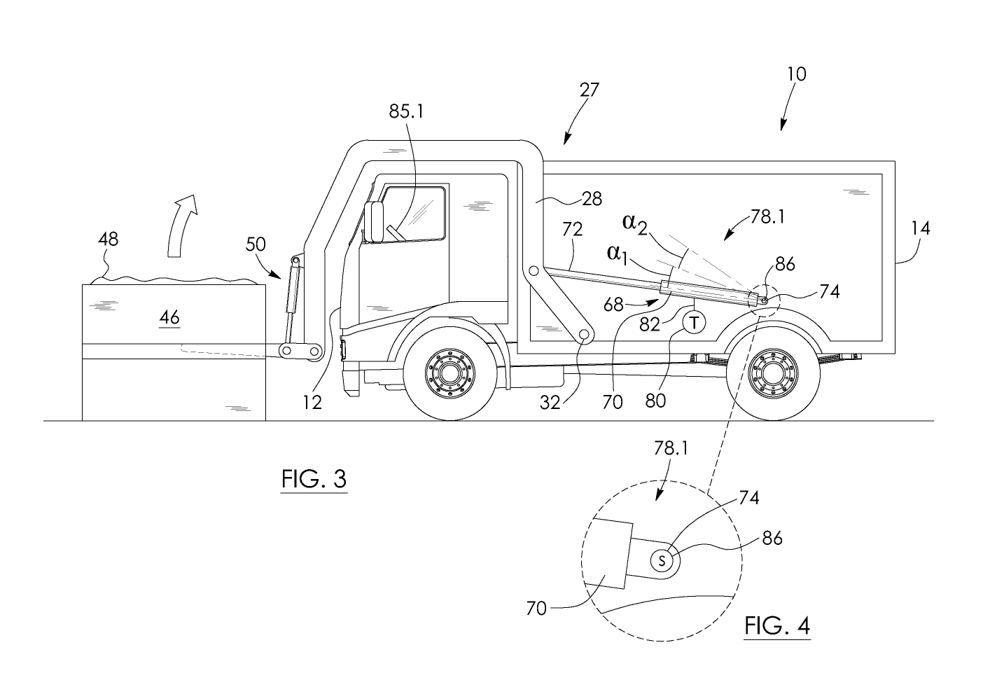

FIGS. 3 and 4 show the vehicle 10 of FIG. 1 together with a load measuring system 78.1 according to a second embodiment. Like parts of system 78.1 have like numbers and functionings as system 78 with the addition of the numeral extension “0.1”. The load measuring system shown in FIGS. 3 and 4 is substantially similar to that shown in FIG. 1 with one exception being that it further includes an angle sensor, in this example magnetic switch 86 operatively mounted to pivot pin 74 and cylinder 70. Switch 86 is conventional and is configured to identify set angular intervals such as angles α₁, α₂ etc., where α₁=α₂ . . . in this example. In another example, a physical, mechanical switch may be used.

In operation, as arms 28 are angularly displaced, switch 86 sends a signal to the computer 85.1 at every increment at which cylinder 70, in this example, spans an angle equal to the angle α. The computer 85.1 is programmed such that, upon receiving the signal from the switch 86, it records the output of the transducer 80.1 for the given position of the cylinder at this interval. This process is repeated and a series of discrete transducer outputs are stored in the computer 85.1 from which the weight of the waste load may be calculated in a similar manner as described for the embodiment shown in FIG. 1. System 78.1 provides the advantage of requiring less computer memory and reading storage capacity in order to operate.

The computer 85.1 may be programmed such that should switch 86 have operational issues or fail, the computer reverts back to storing continuous output readings of the transducer as described in the embodiment shown in FIG. 1.

System 78.1 with its switch 86 may be particularly suited to less dynamic vehicles, such as fork lifts, that do not require as many reference points for determining the weight of a lifted load.

FIGS. 5 to 8 show the vehicle 10 of FIG. 1 together with a load measuring system 78.2 according to a third embodiment specifically adapted for garbage trucks. Like parts of system 78.2 have like numbers and functionings as system 78 with the addition of the numeral extension “0.2”. The load measuring system shown in FIGS. 5 to 8 is substantially similar to that shown in FIGS. 1, 3 and 4 with the exception that, instead of an angle sensor, system 78.2 has a button 88 disposed within the cab 16 and in communication with the computer 85.2. The button sends out a signal upon the button being actuated. The computer is programmed such that, upon receiving the signal from the button, it records the output of the transducer 80.2.

There are five stages for the operator of the garbage truck to follow for system 78.2. Referring to FIG. 5, the first stage is where the waste disposal vehicle 10 has its arms 28 and forks 36 lowered in preparation for picking up a waste load but where the forks are unloaded, free of any payloads. The operator pulls up to waste container 46, enters into the computer or a console its bin number and actuates button 88. This sets the bin number and the GPS location of the truck, and communicates to the computer 85.2 to store a first output or reading of the transducer 80.2 for this position and load reading. From the first output, the computer may determine a first zero-weight reading.

In the second stage and referring to FIG. 6, the operator inserts forks 36 through sleeves 44 of the waste container 46 having waste load 48. The container is raised up slightly such that the container is spaced-apart above the ground 26 and the forks bear the weight of the container and its contents. The operator then actuates button 88 again, signalling to the computer 85.2 to store a second output from the transducer 80.2 for this position and load reading. This sets the bin number with loaded bin. From the second output, the computer may determine the combined weight of the waste container 46 and waste load 48.

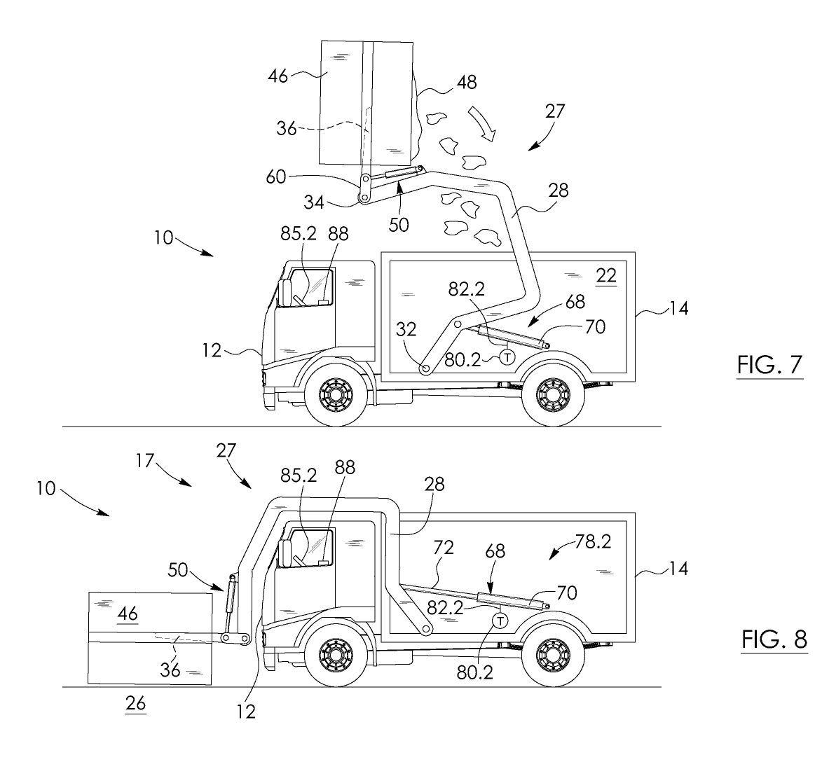

In the third stage shown in FIG. 7, the operator then empties the waste load 48 into the back of the waste disposal vehicle 10. In this stage, arms 28 of the waste disposal vehicle are in an elevated, generally vertical position. Actuators 68 and 50 are in at least partially retracted positions, causing waste load 48 to empty from container 46 and into hopper 22.

In the fourth stage shown in FIG. 8, the operator lowers the forks 36 and now-empty container 46 such that the container is still fully supported by the forks and is slightly spaced-apart above ground 26. The operator actuates button 88, which signals to the computer 85.2 to store a third output from the transducer 80.2 for this position and load reading. From the third output, the computer may determine the weight of the waste container 46. The computer may also determine the weight of the waste load, by subtracting the combined weight of the container and waste load as determined in the second stage from the weight of the container as determined by the third stage. Pressing button 88 may automatically transmit the data to a central control center. The data may or may not be used for calculating the weight of the load and may be used for testing and confirming information in a point of sale manner.

In the last, optional fifth stage, the operator lowers the container 46 to the ground 26 and reverses the waste disposal vehicle 10. Once the forks 36 are free from the sleeves of the container, as shown in FIG. 5, the operator actuates button 88 again, signalling to the computer 85.2 to store a fourth output from the transducer for this position and load reading.

From the fourth output, the computer may determine a second zero-weight reading. One or more of the above stages may be referred to as a means for correlating actuator pressure within the actuator at a set position of the lifting arm with weight for generating a calculated weight of a payload. In theory, the first zero-weight reading determined from the first stage should be equal to the second zero-weight reading determined from the fifth stage. This last step is important for assessing consistency between readings. The extent to which the first and second zero-weight readings differ provides an indication of the margin of error between calculations. The computer may be programmed to take the average of the first and second zero-weight readings when determining the weight of the waste load. The computer may also, for example, be programmed to disregard one of the first and second zero-weight readings if said one of the readings differs too greatly from a predetermined threshold.

In a further variation, instead of button 88, a switch, such as switch 86 shown in FIGS. 3 and 4, may be incorporated into the above garbage truck system. The operator may first enter in a given container's bin number. The operator next lowers the forks downwards past a certain angular position in preparation for picking up the container, which will actuate a first switch position, signalling to the computer to store the GPS and transducer reading at this point. Likewise, a second switch position will be triggered when the forks lift past a second position and this process may be repeated for other positions.

FIGS. 9 and 10 show the vehicle 10 shown in FIG. 1 together with a load weighing system 78.3 according to a fourth embodiment. Like parts of system 78.3 have like numbers and functionings as the embodiment shown in FIG. 1 with the addition of “0.3”. System 78.3 is substantially the same as system 78 shown in FIG. 1 with the exception that, instead of hydraulic transducers, system 78.3 has a plurality of load cells in communication with the computer 85.3, including a pair of load cells 90 connected to the pair of forks 36, respectively, adjacent to ends 38 of the forks, and a plurality of load cells 92 connected to respective corners 94 of the frame 21 of the vehicle. The load cells are schematically in FIG. 9. The load cells 90 and 92 per se are conventional, off-the-shelf components well known to those skilled in the art and therefore their parts and operation per se will not be described in detail. Load cells 90 and 92 are configured to output electrical signals, in this example signals, that correlate to current in milliamps or to volts to the weight of the waste load of a given waste container.

In a like manner as described before, the differences in milliamp outputs from the load cells for adjacent angular positions are the same for a given waste load, regardless of vehicle loads or fork position. Thus, the weight of waste load may be determined from the load cells readings inputted to and captured by the computer 85.3. The computer may be programmed to store a continuous stream of data similar to the embodiment described for FIG. 1, store a plurality of discrete data upon receiving signals from switch 86.3 similar to the embodiment described for FIGS. 3 and 4 and/or store data upon button 88.3 being actuated similar to the embodiment described for FIGS. 5 to 8. The computer may also determine any weight imbalances in the container or vehicle's load via the load cells. Load cell readings are related to pressure readings within a given actuator and thus any of the above may be referred to as a means for correlating pressure within the actuator at a set position of the lifting arm with weight for generating a calculated weight of a payload.

FIGS. 11 to 16 show the vehicle 10 shown in FIG. 1 together with a load weighing system 78.4 according to a fifth embodiment. Like parts of system 78.4 have like numbers and functionings as the embodiment shown in FIGS. 3 and 4 with decimal extension “0.4” replacing decimal extension “0.1”. System 78.4 shown in FIGS. 11 to 16 is substantially the same as system 78.1 shown in FIGS. 3 and 4 with the following exceptions.

Vehicle 10 has transducers 80.4 hydraulically connected to its arm cylinders 70, a pair of transducers hydraulically connected to its fork cylinders 52, as shown by transducer 91, and may also have a pair of transducer (not shown) hydraulically connected to hydraulic cylinders (not shown) for its garbage door (not shown). If vehicle 10 were a fork lift instead of a garbage truck, similarly there may be transducers and hydraulic cylinders for lifting up and down, transducers and hydraulic cylinders for tilting forks, and transducers and hydraulic cylinders for moving the forks side to side.

In order to calibrate accurately, the operator needs only use one of the above mentioned pairs of cylinders and transducers. The other two pairs of cylinders should not have their valves open when the operator is taking readings in this example.

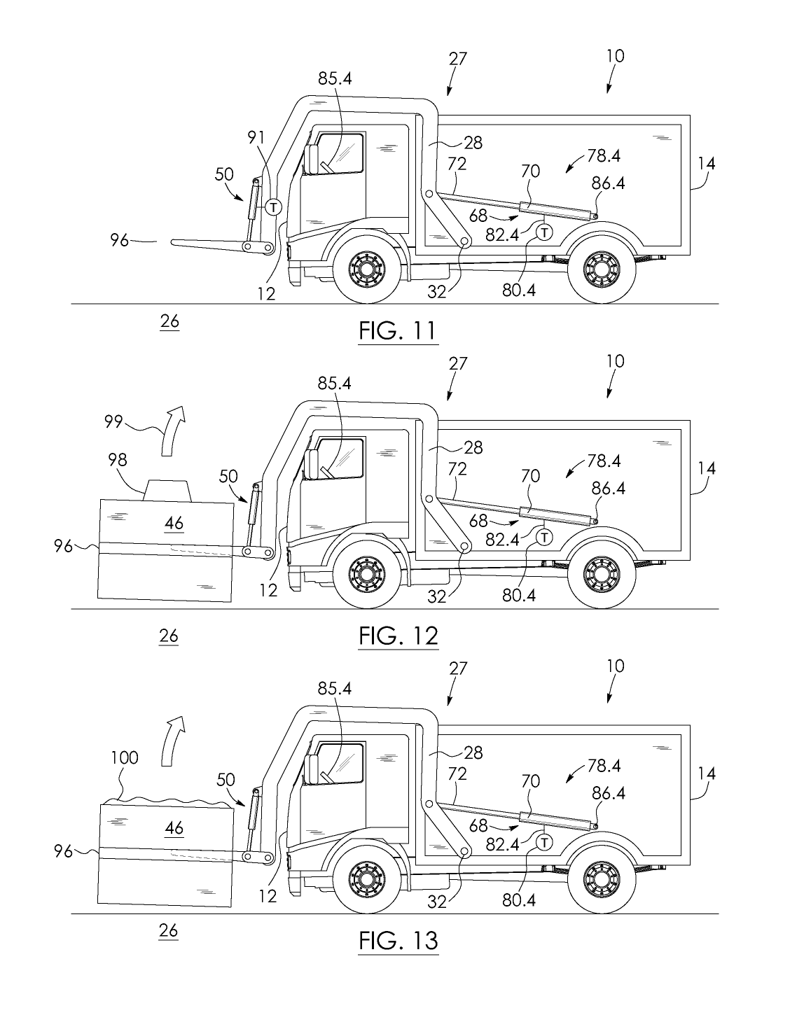

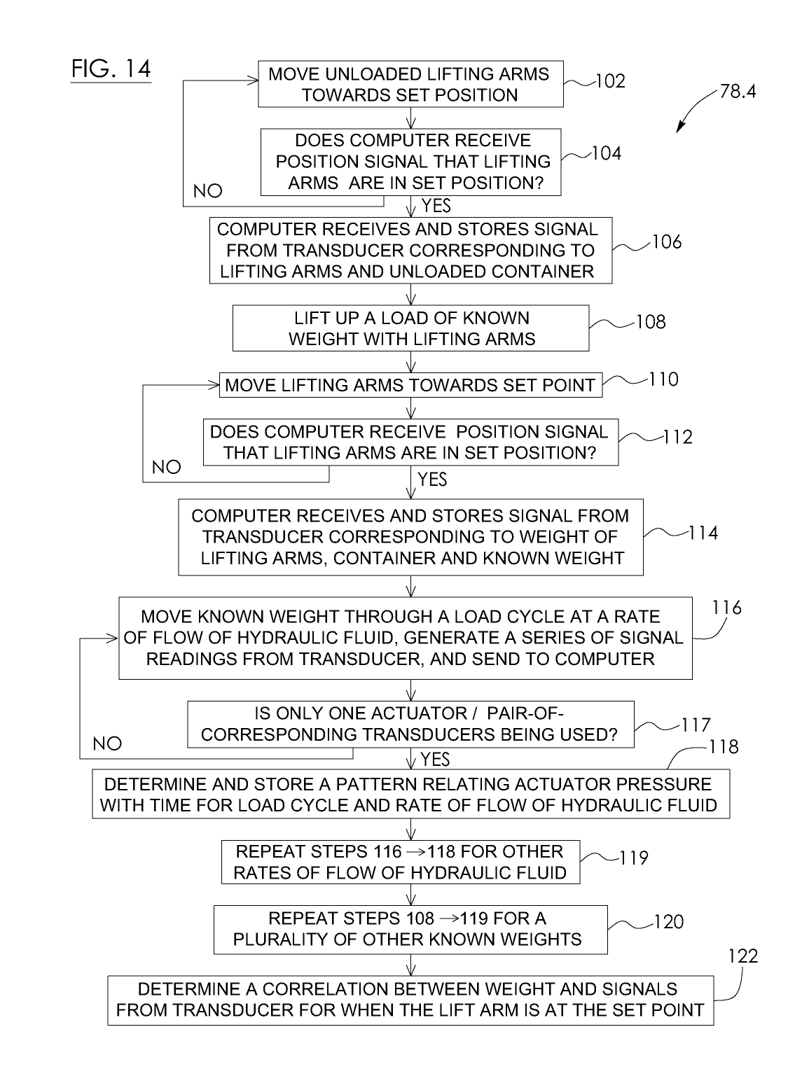

To calibrate system 78.4, lifting arms 28 in an unloaded state are moved to a static, set position 96, which in this example is a position where container 46 is above and approximately parallel with the ground 26 as seen in FIG. 11, though this is not required. This is also shown in box 102 of FIG. 14. The set position may correspond to a specific angular rotation of magnetic switch 86.4, as seen in FIG. 12. If the computer 85.4 does not receive a signal from the switch that the lifting arms 28 are in the set position, the lifting arms must continue to be moved towards the set position. Referring to FIG. 11, upon the computer receiving the signal that the lifting arms 28 are correctly positioned, the computer determines and stores a first signal from the transducer 80.4 corresponding to a value of the weight of part of the lifting arm, and in this example also the weight of the empty container. This is shown as box 106 in FIG. 14. The value of the weight is in terms of the pressure reading of the transducer 80.4 in this example, which converts the pressure reading to a voltage and sends it to the computer 85.4.

Next, a load of known weight 98, as shown in FIG. 12, is disposed on the lifting arms, as seen in FIG. 14 as numeral 108, and is moved to the set position at shown by box 110. Upon determining that the lifting arms are in the set position at box 112, the computer receives a second signal from the transducer. This signal corresponds to the weight of part of the lifting arms, the weight of the container and the known weight. The known weight is next moved through a full load or work cycle 116 at a rate of flow of hydraulic fluid passing into and out of the actuators where the payload is lifted a distance from the set position, such as the load cycle shown in FIGS. 5 to 8.

The computer determines if only one pair of actuators and transducers is being used at box 117 and is active. If yes, the computer determines and stores a pattern relating actuator pressure to time at box 118 based on signals of the transducer at a series of points along the load cycle for the load of known weight and the rate of flow of hydraulic fluid. If no, the computer signals to the operator to repeat the step shown in box 116.

The pressure in the cylinder 70, seen in FIG. 12, changes at different positions. Also, the pressure in an actuator will be higher or lower based on speed at which the lifting arms are moved. However, the pressure versus position pattern will be the same and is repeatable for a given load and a given rate of flow of hydraulic fluid into and out of the cylinder. The load of known weight is moved through the load cycle at a series of rates of flows of hydraulic fluid into and out of the cylinder and steps 116 to 118 are repeated, as shown by box 119. A plurality of patterns for a given load and a plurality of rates of flow of hydraulic fluid thus result and are stored in the computer.

Steps 108 to 119 are repeated for a plurality of other loads of known weights and a plurality of patterns relating pressure to time during the load cycle are generated by the computer, as shown by box 120. These patterns are stored in the memory of the computer. This may be referred to as a means for generating and storing a plurality of set patterns for a plurality of loads of known weight moving through the load cycle for a plurality of rates of flows of hydraulic fluid passing into and out of the actuator

FIG. 16 shows examples of the patterns relating pressure to time for set weights for a fork lift moving through load cycles. The graph shows three sets of patterns 121, 123 and 125 for loads of known weights corresponding to 754 pounds, 559 pounds and 559 pounds, respectively, in this particular example, moved at different speeds, or rates of flow of hydraulic fluid, by the lifting arms. For example, if one lifted 1000 pounds, one might lift slowly and receive an x psi reading. If one lifted 800 pounds and lifted faster, one might get the same x psi reading. As seen in the graph, the pattern or pressure reading is consistent when lifting the arms at a given speed or rate of flow of hydraulic fluid. This is shown by a plurality of peaks, as shown by peaks 127 and 129 for pattern 121 when lifting a load of 754 pounds three times. The peaks 127 and 129 each read at about 980 psi. The weights, pressures and other values would differ in other embodiments. The system reads values from peaks 127 and 129, for example, at certain intervals.

The patterns are also consistent when lowering the lifting arms. This is shown by troughs 131 and 133 for pattern 125.

Put another way, patterns recorded and shown in FIG. 16 confirm that pressure is relative to weight and time. For example, 559 lbs will reflect a relative pressure based on the amount of time the pressure reading is recorded. The pressure may change during the recording time which will indicate that the speed of lifting or dropping has changed since the weight has not changed.

An indication of the speed with which the lifting arms are moved is determined by the computer based on the distance between adjacent lines of the pattern generated from lifting and lowering the load, respectively. The space between lines represents the number of readings over time, which provides a reliable time reference. In this example the x axis represent reading numbers and there are approximately 10 readings per second. Lines 137 and 138, corresponding to lifting and lowering for pattern 123 for a weight of 559 pounds, are spaced-apart by an average distance D₁. Peaks 127 and 129 represent times when the lifting. With the rate of flow of hydraulic fluid into the cylinder kept constant, the pressure readings will be consistent at the peaks 127 and 129. The same holds for the rate of flow of hydraulic fluid out of the cylinder.

Lines 141 and 143, corresponding to lifting and lowering for pattern 125 for the same weight of 559 pounds, are spaced-apart apart by an average distance D₂ which is less than D₁. The closer these lines are, the faster the lifting arms are moving. If one combines a load having a known weight with a calculated rate of flow of hydraulic fluid into the cylinder, dynamic repeatable patterns result which the computer determines and stores in its memory for comparing with the pattern of a payload of unknown weight.

The computer 85.4 next correlates therefrom at 122 a relationship between the plurality of signals and weight on the lifting arm. In this example, this is done by using the plurality of signals for the plurality of loads of known weights where the lifting arms are in the set position and determines a relationship between weight and pressure thereby. To zero the relationship, computer 85.4 may determine a value of the combination of the known weight 98 and the weight of the lifting arm and container in terms of pressure. The computer next subtracts the value of the combination of the known weight and the weight of the lifting arm to determine a value of the known weight 98 in terms of pressure. With a sufficient number of known weights, the computer may determine a correlation between a given pressure reading of the transducer 80.4 and a given weight thereby. This may be referred to as a means for correlating actuator pressure within the actuator at a set position of the lifting arm with weight for generating a calculated weight of a payload

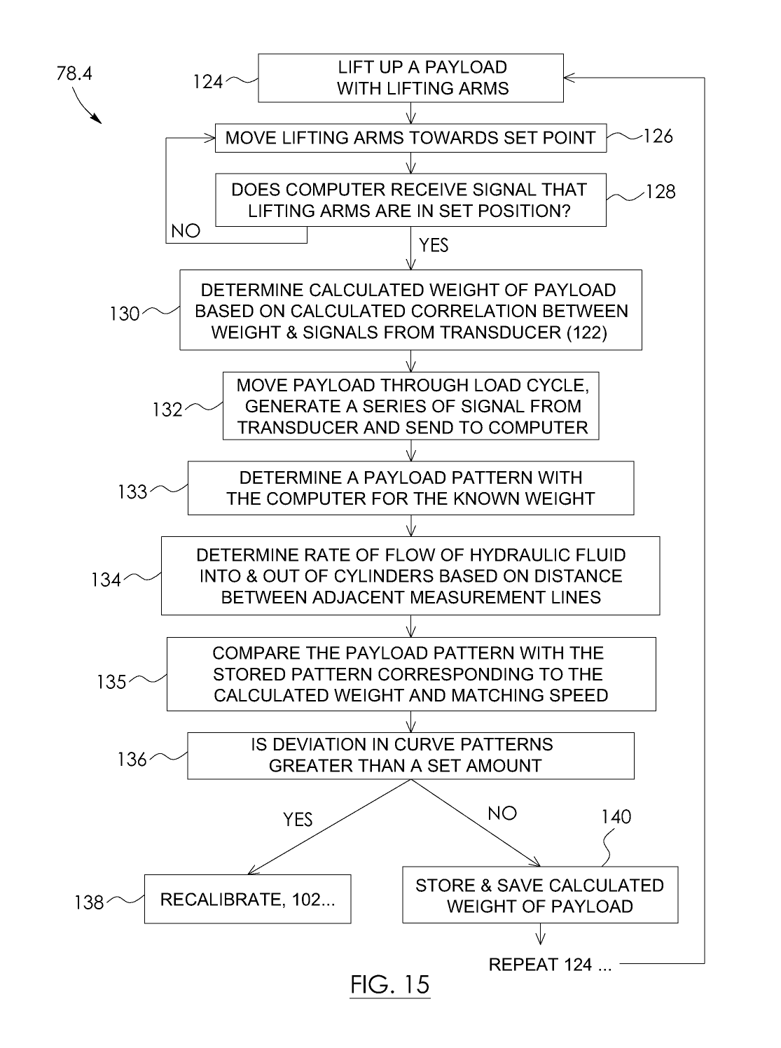

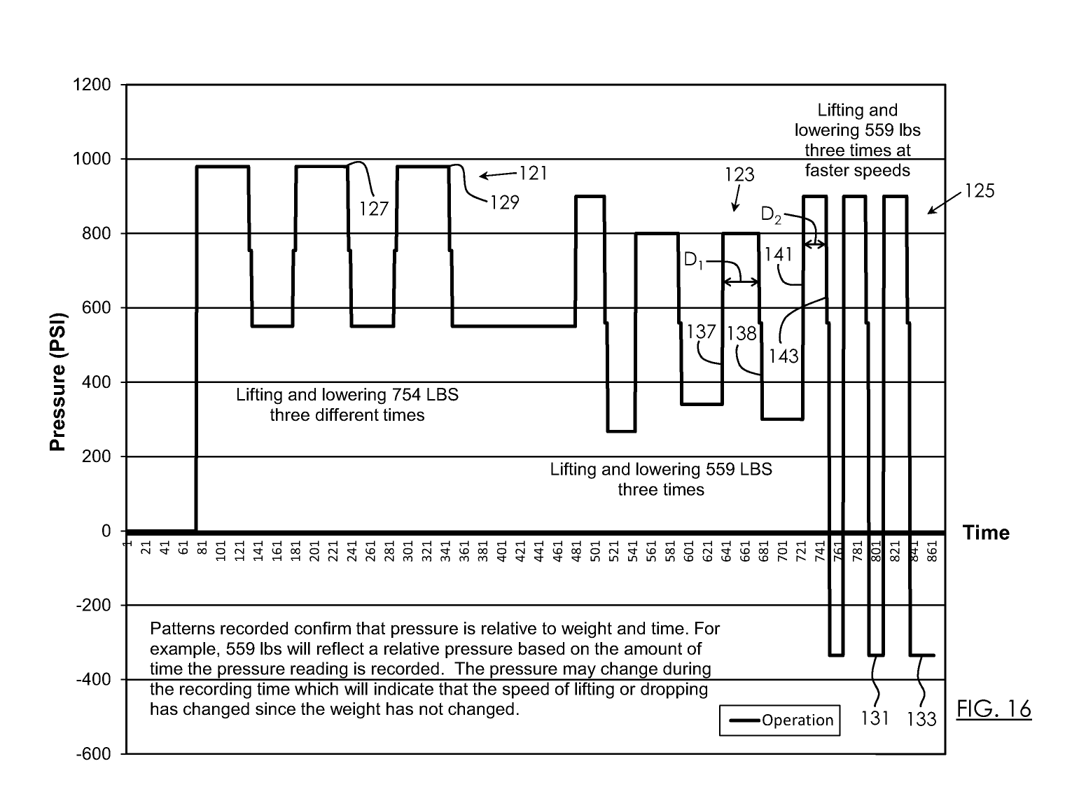

As seen in FIG. 13, the operator may next position a payload 100, which in this example is but need not be a waste load, on the lifting arms 28 while the lifting arms are in the set position. This is shown as boxes 124 and 126 in FIG. 15. Upon the lifting arms being correctly positioned at 128, the computer determines at 130 a third signal from the transducer while the lifting arm is in the set position, and determines a calculated weight of the payload based on the calculated relationship between weight and the signals of the transducer 122.

Thus, system 78.4 as herein described determines the calculated weight of the payload when the vehicle 10 and payload 100, seen in FIG. 13, are at rest in this example. However, it is not strictly necessary to determine the calculated weight of the payload when the vehicle and payload are at rest. The other means for correlating transducer signals and weight as described for FIGS. 1 to 10 may also be used in alternative embodiments for calculating the weight of the payload, for example.

Referring back to FIG. 15, the payload is next moved through the load cycle 132 for at a rate of flow of hydraulic fluid passing into and out of its cylinders, and the transducer sends a plurality of signals at a series of points along the load cycle. The computer determines at 133 a payload pattern based on the series of points. This may be referred to as a means for generating a payload pattern relating actuator pressure to time upon moving a payload through a load cycle.

The computer next determines the rate of flow of hydraulic fluid passing into and out of the actuators of the lifting arms when moved during the movement of the payload through the load cycle based on the distance between adjacent measurement lines of the pattern corresponding to where the payload was lifted and lowered, respectively. The rate of flow of hydraulic fluid into and out of the actuators relates to the speed with which the actuators and lifting arms move. This is shown as box 134. This is also shown by lines 137 and 138 for pattern 123 and lines 141 and 143 for pattern 125 in FIG. 16.

Referring back to FIG. 15, at 135 the computer compares the payload pattern for the calculated rate of flow of hydraulic fluid into and out of the cylinder with a stored pattern corresponding to both the calculated weight of the payload and the rate of flow. In this case, the computer can determine if the upper peak (rate of flow while lifting) and lower peak (rate of flow while lowering) patterns shown in FIG. 16 match up for the criteria. The computer determines at 136 if the deviation in patterns is greater than a set amount.

If so, the computer signals at 138 that the system 78.4 must be recalibrated, by going to step 102 in FIG. 1. This may be referred to as means for recalibrating the correlation between actuator pressure and weight if the deviation between the patterns is greater than a certain set amount.

If the deviation is acceptable at 140, the computer stores and saves the calculated weight of the payload. The system then repeats the above steps beginning with step 124 for the next payload. This may be referred to as a means for comparing the payload pattern with a set pattern relating actuator pressure to time corresponding to the calculated weight of the payload and rate of flow of hydraulic fluid and recalibrating the correlation between actuator pressure and weight if the deviation between the patterns is greater than a certain amount. Alternatively, it may be referred to as a means for generating a pattern relating pressure to time for the payload when payload moves through a load cycle and verifying the calculated weight with one of the set patterns corresponding to both the calculated weight of the payload and the rate of flow of hydraulic fluid with which the payload was moved through the load cycle.

Thus, the system 78.4 as herein described uses the information derived from actual payload patterns and compares them to stored patterns to determine if the calculated weight of the payload is accurate. In this manner, the weight of a plurality of payloads may be calculated and stored in the computer in an accurate and reliable manner.

According to one embodiment, the deviation between the patterns is equal to or less than 5% for safety applications where the operator wants to ensure that his load-lifting vehicle is not overloaded. Thus, in this example if a set number of payload curve points are accurate within 5% compared to the series of curve points of the known load for the same flow rates of hydraulic fluid while lifting and lowering the arms, the calculated weight of the payload is accepted and stored in the computer. For trade applications where the amount of load transported needs to be determined and tracked with greater accuracy, the deviation between the patterns is equal to or less than 0.5% according to one example. The system as herein described may have 0.1% weight measurement accuracy for fork lifts. The system as herein described may have 0.25% weight measurement accuracy or better for garbage trucks.

In one variation, the system as herein described may compare a portion of the beginning of the payload pattern towards the beginning of the load cycle with a portion of the beginning of the set pattern. This is because, typically, an operator will begin lifting his load at a slow, more constant speed manner. This may be referred to as means for comparing a portion of the beginning of the payload pattern towards the beginning of the load cycle with a portion of the beginning of the set pattern.

Advantageously, the system 78.4 as herein described enables an operator to verify weight readings while the vehicle is in motion. Thus, the system as herein described may calculate the weight of a payload while the vehicle is idle and verify the calculated weight while it is moving and performing tasks. This may save time and result in a more accurate system. Alternatively, the system may be readily adapted to calculate the weight of a payload while the vehicle is moving using the patterns and verify the calculated weight while idle.

The system 78.4 as herein described only stores data when only one actuator/pair-of-corresponding-transducers is being used as shown in box 117 of FIG. 14. Alternatively, the operator can combine the readings of different transducers where more than one of the valves of cylinders 70 and 50 is open, for example. The patterns resulting from these transducers may be combined and used as a further means for establishing set patterns for comparing with payload patterns. Thus, in this case, the payload pattern may be determined and cross-checked based on the calculated weight of the payload, its corresponding patterns listed for this weight, the speed of the lifting arms as determined by the spacing between adjacent measurement lines of the pattern arising from the lifting arms lifting up and lower, and based on the number of valves of actuators that may be open. The spacing between adjacent measurement lines corresponds to the number of readings over time.

According to a further variation, the patterns referred to above may be used to self-calibrate the system. For example, if a weight of 800 pounds results in a pressure reading of 900 psi with a calibrated base of 0 pounds equaling 0 psi, then the patterns as herein described may indicate a pressure reading of 900 psi, for example. If the base psi pressure drifts to 5 psi from 0 psi, then the resulting pressure reading of 900 psi would increase to 905 psi. The patterns remain the same for a given weight and rate of flow of hydraulic fluid with a 5 psi increase overall and would simply be offset by 5 psi. Advantageously, the patterns so stored enable the computer 85.4 to identify the patterns so offset and to self-adjust the calibration of the system accordingly. This may be referred to a means for using the patterns to identify and determine drift in pressure readings and for self-adjusting for said drift in pressure readings thereby.

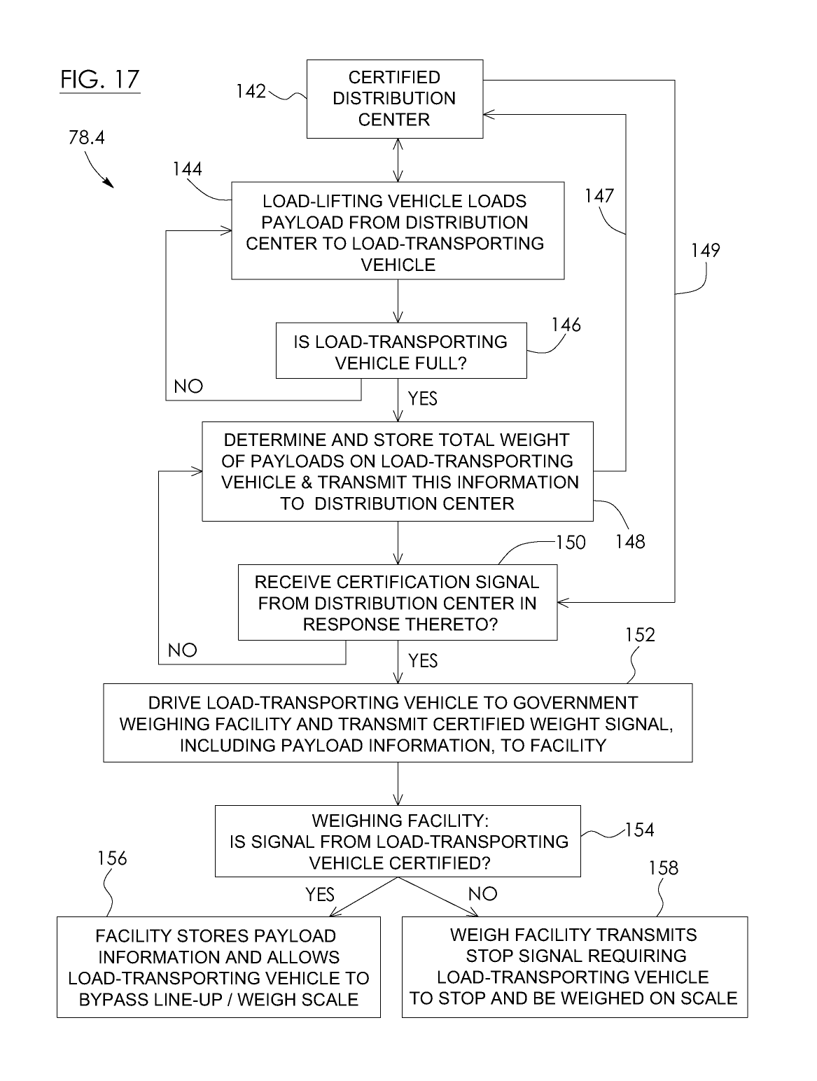

System 78.4 may be used as part of a method of tracking payloads as shown in FIG. 17. In this case, there is provided at 142 a certified distribution center. The center has a series of payloads which may be pallets or bins for example. A load-lifting vehicle loads a series of these payloads from the center onto a load-transporting vehicle such as a truck, and as is generally shown by box 144. When the load-lifting vehicle lifts up the payload, the weight data, as calculated by any of the above mentioned systems, is stored in a computer database. When each payload is loaded onto to the truck, the weight data as calculated in the above mentioned system 78.4 goes into a database. This may be done by calculating the difference between when readings the load-lifting vehicle is carrying the payload and when the load-lifting vehicle is unloaded. Alternatively, this may be determined by load monitoring equipment also installed on the truck. Thus, every load lifted is weighed and put in the database, and every load put in the truck is weighed and put into the database. Individual pallets/bins and the total weight are recorded.

If the transporting vehicle is not fully loaded at 146, loading continues at 144. If the transporting vehicle is fully loaded, the computer determines and stores the total weight of payloads transported by the load-lifting vehicle onto a load-transporting vehicle by way of the load monitoring system 78.4 as described above and as generally shown by box 148. This information is transmitted 147 to and kept at the distribution center at 142. The information is also stored in the load-transporting vehicle for the truck driver, for example, to observe the information in real time.

The distribution center in response sends a certification signal 149 to the transporting vehicle, as shown by box 150. If the certification signal is not received, the transporting vehicle again sends its transmitting signal to the center. If the certification signal is received, the transporting vehicle next drives to a central weighing facility, in this example a government or municipal weighting facility and transmits a certified weight signal in response to the weighing facility, as generally shown by box 152. The certified weight signal correlates with the certification signal of box 150, indicates that the load-transporting vehicle is certified and indicates the total weight of the payloads carried by the transporting vehicle.

The weighing facility determines at 154 if the certified weight signal is indeed certified. If yes, the facility stores the payload weight information and signals to the load-transporting vehicle to bypass any line-up and weigh scale and proceed directly to its end destination. The weighing facility thereby allows transporting vehicles coming from certified distribution centers to bypass weigh scales and enables the transporting vehicle to move its goods in a time efficient manner. This is shown generally by box 156.

If the weighing facility determines that the signal is not certified or if it detects an error signal of some kind, the facility transmits a stop signal to the transporting vehicle requiring that the transporting vehicle be weighed on the scales. At 158, if the transporting vehicle is not certified by the distribution center, if the transporting vehicle comes from a non-certified distribution center, or if there is some other error, the weighing facility may stop the transporting vehicle from passing by sending out the stop signal.

The vehicle can be tracked by GPS. This may be a factor in determining whether the driver is to be authorized to bypass the scale. This is because if the driver has taken too long to get the facility, the driver may have gone to another stop and changed his load. Alternatively, the GPS route data may indicate that the driver stopped at another location, which may be another factor for the facility to stop the vehicle.

Because of the accuracy provided by system 78.4, the method of tracking may further include a charging-by-weight feature, by charging the distribution center or other user of the system at a fixed rate of value per unit of weight of payload for the use of the system 78.4. One could charge the user of the system at a rate of 1/10^{th} or 1/100^{th} of a cent per pound of payload moved, for example. In this manner, the method of tracking may provide the user of the system 78.4 with the advantage of lower up-front costs. This charging-by-weight feature may be instead of or in addition to selling and/or licensing the systems 78.4 as separate units.

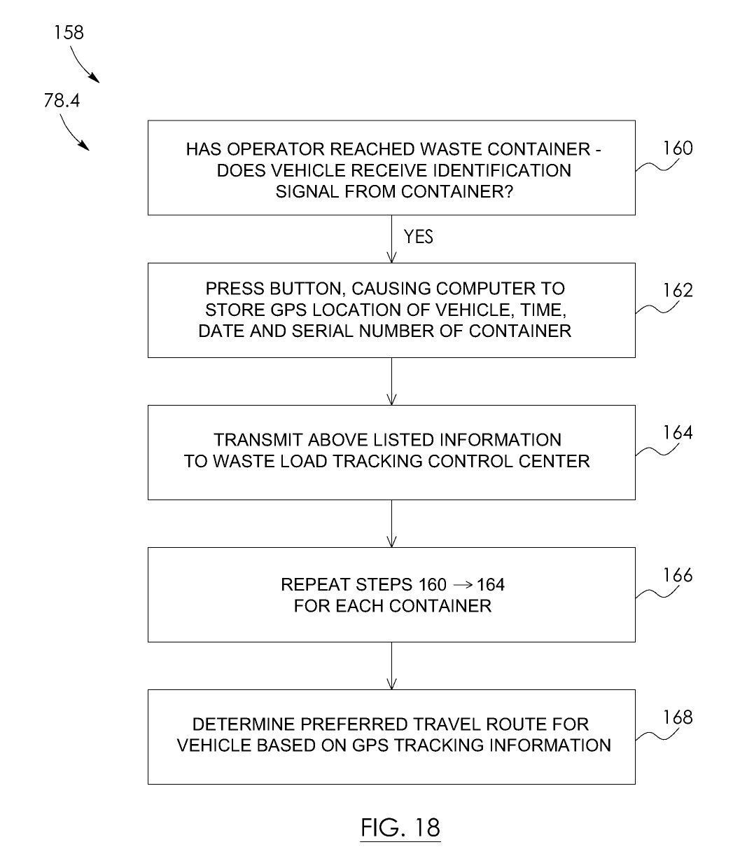

In a sixth embodiment or variation of the invention and as shown in FIG. 18, a GPS system 158 may be associated with each vehicle for tracking the specific route of each vehicle as it moves from one container to the next. Each given container may transmit an identification serial number and location. The system 78.4 may receive an identification signal from the container when the vehicle has reached the bin, as shown by box 160. The computer may be programed such that when the button within the cab of the vehicle is actuated, the computer may simultaneously store the GPS location of the vehicle, the time and the date, and container identification serial number and location information. This is shown by box 162. This may be referred to as a providing the system with a means when actuated for causing the system to store the time, date and serial number of a garbage bin.

All of this information may be transmitted at 164 in real time to a waste load tracking control center through, for example, wireless or cellular transmission. The steps shown in boxes 160 to 164 may then be repeated for each container along the vehicle's route, as shown by box 166. The computer may determine at 168 a preferred travel route for the vehicle based on the GPS tracking information, which is particularly advantageous for a new or temporary driver not familiar with the optimal approach routes and paths for the waste disposal vehicle to approach containers in a given neighbourhood. By pressing a button, the computer with its data thus stored may readily pull up on its display a tailored map for preferred approach routes.

This may be particularly useful, for example, to inhibit a driver from approaching an alley in the wrong direction such that the forks of the waste disposal vehicle cannot pick up a garbage bin. If a waste disposal vehicle has, for example, one hundred garbage bins to pick up in a given route, entering the alley the wrong way may force the driver to turn his vehicle around and this may result in a loss of 10 or 15 minutes, for example.

The computer as herein described for each of the load weighing systems may comprise a CPU (computer processing unit), memory, analog to digital converters, USB ports, a memory card reader, a serial port, a modem, a plurality of connector ports for connecting to a variety of devices and an expansion slot. The following devices may connect to the computer: two-way radios to send and receive data, a cellular phone, a GPS receiver to collect location data, a WIFI system to send and receive data, and a radio-frequency identification (RFID) system to collect asset data and to send and receive data, and input-output (I/O) devices to connect to vehicle computers and record speed, hours, mileage and pressure readings.

The data collected by the systems as described herein may be used for a variety of operational, administrative and analysis purposes. The systems thus may represent an all-in-one solution and system for load-lifting vehicles that incorporates weight load tracking, data management, paper reduction, data automation, real time data analysis, targeted billing capabilities, mapping functions and a general communication system. The system as herein described may thus replace other, more incomplete solutions and provide a single platform with which companies can expand.

Many further advantages result from the structure of the present invention. The load measuring systems as herein described may adapt to any dynamic environment, are self-calibrating and may be more accurate and reliable compared to existing systems. The systems as herein described provide the advantage of being readily operational with a large variety of load-lifting vehicles, including a large variety of waste disposal vehicles of different sizes, cabs, frames, arms and fork configurations and associated different vehicle loads and dynamics. The load measuring systems as herein described provide reliable measurements of the weight of a waste load regardless of the above set out variations in mechanical characteristics of the vehicles, as well as regardless of further potentially complicating variables such as differing inclines or declines in ground surfaces to which the vehicle may be subjected at any given time and variations in the positioning of the waste containers on the forks. This accumulated, more reliable and accurate information may provide opportunities for increased productivity and profits.

The computer and software aspects of the system as herein described provide the advantage of keeping track of fleet assets in real time and the ability to export collected information to accounting systems.

The load measuring systems as herein described may be used in association with a large variety of vehicles in addition to waste loading vehicles. Other load-lifting vehicles with which the load measuring system as herein described may be used include: excavators, log loaders, fork lifts, shipping container lifts, rock quarry vehicles and any other vehicle or machine that lifts loads via hydraulics. The systems as herein described may be used for hydraulic cranes, which have multiple hydraulic actuators.

It will be appreciated that still further variations are possible within the scope of the invention described herein. For example, the computer as herein described may have a plurality of analog to digital converters for converting outputs from multiple transducers into digital readings in this example. Thus, the system has the capacity for receiving multiple output signals from an unlimited number of transducers or load cells. In one preferred example, the computer may have nine sensor inputs, though not limited to such. The computer thus also has the ability to replace the computers of competitors and also integrate with existing load measuring systems.

The load measuring systems as herein described may include a pair of hydraulic transducers. In other embodiments only one hydraulic transducer may be used, particularly if awareness and measurement of load imbalances between arms is not important. The specific configuration and number of the load cells for system 78.2 shown in FIG. 8 may vary and is not intended to be so limited. The transducers may be connected elsewhere along the hydraulic system. The measurements will vary based on the specific location at which they are connected.

It will be understood by someone skilled in the art that many of the details provided above are by way of example only and are not intended to limit the scope of the invention which is to be determined with reference to the following claims.

1. A system for monitoring payload for a load-lifting vehicle, the vehicle having a lifting arm and a hydraulic actuator operatively connected to the lifting arm, the system comprising:
means for correlating actuator pressure within the actuator at a set position of the lifting arm with a known weight for generating a calculated weight of a payload;
means for generating a payload pattern relating actuator pressure to time as the lifting arm moves the payload through a load cycle; and
means for comparing the payload pattern with a known, set pattern relating pressure to time corresponding to said calculated weight of the payload and storing the calculated weight of the payload into memory if the deviation between the patterns is equal to or less than a certain amount.

2. The system as claimed in claim 1, wherein the patterns are generated from the rate of flow of hydraulic fluid passing into and out of the actuator, time intervals between collected samples, weight on the lifting arm and the resulting hydraulic pressure in the actuator.

3. The system as claimed in claim 1, further including within the means for comparing, means for recalibrating the correlation between actuator pressure and weight if the deviation between the patterns is greater than a certain amount.

4. The system as claimed in claim 1, further including means for generating and storing a plurality of set patterns for a plurality of loads of known weight moving through the load cycle for a plurality of rates of flows of hydraulic fluid passing into and out of the actuator, the means for comparing including comparing the payload pattern with a set pattern having a rate of flow of hydraulic fluid passing into and out of the actuator equal to that for the payload pattern.

5. The system as claimed in claim 1, wherein the means for correlating actuator pressure with weight includes a pressure transducer hydraulically connected to the actuator and a microprocessor, the transducer sending a first signal to the microprocessor when the lifting arm is in an unloaded state and sending a second signal to the microprocessor when the lifting arm is lifting a load of known weight, the microprocessor correlating a relationship between the first signal and the second signal and weight on the lifting arm therefrom.

6. The system as claimed in claim 1, wherein the means for correlating and the means for generating the payload pattern include:
a transducer operatively connected to the actuator, the transducer sending out electrical outputs related to hydraulic pressure within the actuator; and
a microprocessor configured to receive the outputs of the transducer,
whereby the microprocessor determines the weight of the payload and the payload pattern based on the outputs of the transducer between adjacent angular positions of the actuator.

7. The system as claimed in claim 1, wherein the means for correlating and the means for generating the payload pattern include:
an angle sensor configured to measure angular positions of the actuator and send out electrical outputs related thereto; and
a microprocessor configured to receive the outputs of the angle sensor and determine when the lifting arm is in the set position thereby.

8. The system as claimed in claim 1, wherein the means for correlating and the means for generating the payload pattern include:
a load cell connected to the vehicle, the load cell sending out an electrical output related to the weight of the load; and
a microprocessor configured to receive the output of the load cell,
whereby the microprocessor determines the weight of the load and the payload pattern based on the outputs of the load cell between adjacent angular positions of the lifting arm.

9-11. (canceled)

12. The system as claimed in claim 1, wherein the means for comparing the payload pattern with the set pattern corresponding to said calculated weight of the payload includes means for comparing portions of the patterns located adjacent to the beginning of the load cycle where loads are beginning to be lifted.

13. The system as claimed in claim 1, wherein the deviation is equal to or less than 5%.

14. The system as claimed in claim 1, wherein the deviation is equal to or less than 0.5%.

15. The system as claimed in claim 1, the means for correlating including measuring pressure readings and the system further including:
means for using the patterns to identify and determine drift in pressure readings and for self-adjusting for said drift in pressure readings thereby.

16. A method of tracking payloads using the load monitoring system of claim 1, the method comprising:
determining the total weight of payloads transported by the load-lifting vehicle onto a load-transporting vehicle by way of the load monitoring system of claim 1 and transmitting this information to a certified distribution center; and
the load-transporting vehicle receiving a certification signal from the distribution center in response thereto, and transmitting a certified weight signal thereafter to a weighing facility, the certified weight signal indicating that the load-transporting vehicle is certified and indicating the total weight of the payloads.

17. A method of tracking payloads using the load monitoring system of claim 1, the method comprising:
determining the total weight of payloads transported by the load-lifting vehicle onto a load-transporting vehicle by way of the load monitoring system of claim 1 and transmitting this information to a central database; and
charging the load-transporting vehicle at a fixed rate of value per unit of weight of payload for the use of the system as claimed in claim 1.

18. A fleet asset tracking method using the load monitoring system of claim 1, the load-lifting vehicle being a waste disposal vehicle that lifts a waste container, the waste container transmitting a GPS location data point, and the method comprising:
identifying the GPS location data point for the waste container;
storing said data point in a computer; and
generating a preferred travel and approach route for the vehicle based on said data point.

19. The method of claim 18, further including:
disposing an identification tag on the waste container;
receiving an identification signal when the vehicle is adjacent to the waste container; and
providing the system with a means for causing the system to store the time, date and serial number of the waste container.

20. A payload monitoring system for a load-lifting vehicle having a lifting arm and a hydraulic actuator operatively connected to the lifting arm, the system comprising:
means for determining a calculated weight of a payload when the payload is stationary;
means for generating and storing a plurality of set patterns relating actuator pressure to time as the lifting arm moves through a load cycle for a plurality of loads of known weights moved through the load cycle under a plurality of rates of flow of hydraulic fluid passing into and out of the actuator; and
means for generating a payload pattern relating actuator pressure to time as the lifting arm moves the payload through the load cycle and verifying the calculated weight of the payload with one of the set patterns generated from both a load of known weight corresponding to said calculated weight of the payload and a rate of flow of hydraulic fluid passing into and out of the actuator corresponding to that at which the payload was moved through the load cycle.

21. A method of monitoring payload for a load-lifting vehicle, the vehicle having a lifting arm and a hydraulic actuator operatively connected to the lifting arm, the method comprising:
hydraulically connecting a transducer to the actuator for sensing pressure therein, the transducer converting said pressure into electrical signals related thereto;
positioning the lifting arm in an unloaded state to a set position and determining a first signal from the transducer in the set position;
disposing a load of known weight on the lifting arm, determining a second signal from the transducer while the lifting arm is in the set position, and correlating a relationship between the first signal and the second signal and weight on the lifting arm therefrom;
positioning a payload on the lifting arm, determining a third signal from the transducer while the lifting arm is in the set position, and determining a calculated weight of the payload based on said relationship;
moving the payload through a load cycle at a rate of flow of hydraulic fluid passing into and out of the actuator where the payload is lifted a distance from the set position, measuring signals of the transducer at a series of points along the load cycle, generating a payload pattern based on said series of points, and comparing the payload pattern with a set pattern corresponding to said calculated weight of the payload and said rate of flow of hydraulic fluid; and
repeating the above steps if the deviation between the payload pattern and the set pattern is greater than a certain amount.

22. The system as claimed in claim 2, wherein the rate of flow of hydraulic fluid passing into and out of the actuator corresponds to a speed with which the lifting arm is moved.

23. The system as claimed in claim 20, wherein the plurality of rates of flows of hydraulic fluid passing into and out of the actuator correspond to a plurality of speeds with which the lifting arm is raised and lowered.
